(19) United States
(12) Patent Application Publication
(10) Pub. No.: US 2022/0294018 A1
(43) Pub. Date: Sep. 15, 2022

(54) SOLID-STATE BATTERY

(71) Applicant: HONDA MOTOR CO., LTD., Tokyo (JP)

(72) Inventors: Satoshi AOKI, Saitama (JP); Michimasa TABUCHI, Saitama (JP); Yayoi MATSUSHITA, Saitama (JP)

(21) Appl. No.: 17/680,320

(22) Filed: Feb. 25, 2022

(30) Foreign Application Priority Data
Mar. 11, 2021 (JP) 2021-039615

(51) Int. Cl. H01M 10/0585; H01M 10/0525; H01M 50/593

(52) U.S. Cl. CPC H01M 10/0585; H01M 10/0525; H01M 50/593; H01M 2300/0065

(57) ABSTRACT

There is provided a solid-state battery which can prevent short circuiting or breakage from occurring in electrode layers in individual laminates due to rolling when the stacked laminates are subjected to a high-pressure pressing process. A solid-state battery includes a laminate in which a positive electrode collector, a positive electrode active material layer, a solid electrolyte layer, a negative electrode active material layer, and a negative electrode collector are stacked in this order, and a conductive rigid body including a rigid body having electrical conductivity, wherein the laminate and the conductive rigid body are alternately stacked, and the conductive rigid body is provided on each outermost side in a stacking direction.

This application is based on and claims the benefit of priority from Japanese Patent Application 2021-039615, filed on 11 Mar. 2021, the content of which is incorporated herein by reference.

### BACKGROUND OF THE INVENTION

### Field of the Invention

The present invention relates to a solid-state battery.

### Related Art

In recent years, there has been proposed a technique relating to a solid-state battery using a solid electrolyte, which has a high energy density and high safety against heat. When a solid-state battery is used for applications requiring a large current and a high voltage, such as for a motor drive of an electric vehicle or a hybrid vehicle, a solid-state battery module modularized by combining a plurality of single cells is used.

Patent Document 1 discloses a configuration in which a laminate constituting a solid-state battery is housed in a laminate film as an exterior packaging body and a plurality of laminated solid-state batteries are combined to form a battery module.

Patent Document 2 discloses a method of manufacturing a solid-state battery comprising a step of pressing a laminate in which a positive electrode layer including a positive electrode collector and a positive electrode active material, a solid electrolyte layer, and a negative electrode layer including a negative electrode active material layer and a negative electrode collector are stacked in this order.
Patent Document 1: Japanese Unexamined Patent Application, Publication No. 2019-102261
Patent Document 2: Japanese Unexamined Patent Application, Publication No. 2020-061258

### SUMMARY OF THE INVENTION

The solid-state battery disclosed in Patent Document 1 is formed by sandwiching a plurality of solid-state batteries between plates and pressurizing and fixing the plurality of solid-state batteries, but when multi-stacked cells of the solid-state battery are simply pressed at a high pressure, short circuiting or breakage may occur in the electrode layers of the individual solid-state batteries due to rolling.

In the case where the method of manufacturing a solid-state battery disclosed in Patent Document 2 is applied to manufacturing of a solid-state battery, it is necessary to stack a predetermined number of laminates after a vast number of laminates are individually pressed, but these steps are bottlenecks, resulting in low manufacturing capability.

The present invention has been made in view of the above, and an object of the present invention is to provide a solid-state battery which can prevent short circuiting or breakage from occurring in electrode layers in individual laminates due to rolling when the stacked laminates are subjected to a high-pressure pressing process.

(1) In order to achieve the above-described object, the present invention provides a solid-state battery comprising a laminate in which a positive electrode collector, a positive electrode active material layer, a solid electrolyte layer, a negative electrode active material layer, and a negative electrode collector are stacked in this order, and a conductive rigid body including a rigid body having electrical conductivity, wherein the laminate and the conductive rigid body are alternately stacked, and the conductive rigid body is provided on each outermost side in a stacking direction.

(2) In addition, the present invention provides a solid-state battery comprising an assembly in which a pair of laminates each in which a positive electrode collector, a positive electrode active material layer, a solid electrolyte layer, a negative electrode active material layer, and a negative electrode collector are stacked in this order are stacked so that the positive electrode collectors of the pair of laminates contact each other, and a conductive rigid body including a rigid body having electrical conductivity, wherein the assembly and the conductive rigid body are alternately stacked and the conductive rigid body is provided on each outermost side in a stacking direction.

(3) In the solid-state battery of (1) or (2), edges in a planar direction of the positive electrode active material layer may be provided on an inner side in the planar direction with respect to edges in the planar direction of the solid electrolyte layer that is adjacent to the positive electrode active material layer.

(4) The solid-state battery of any one of (1) to (3) may further comprises an insulating spacer provided outside in a planar direction of the positive electrode active material layer.

According to the present invention, there can be provided a solid-state battery which can prevent short circuiting or breakage from occurring in electrode layers in individual laminates due to rolling when the stacked laminates are subjected to a high-pressure pressing process.

### BRIEF DESCRIPTION OF THE DRAWINGS

FIG. 1 is an exploded cross-sectional view of a solid-state battery according to a first embodiment of the present invention;

FIG. 2 is an exploded cross-sectional view of a solid-state battery according to a second embodiment of the present invention;

FIG. 3 is an exploded cross-sectional view of a solid-state battery according to a third embodiment of the present invention;

FIG. 4 is an exploded cross-sectional view of a solid-state battery according to a fourth embodiment of the present invention;

FIG. 5 is an exploded cross-sectional view of a conventional solid-state battery; and

FIG. 6 is an exploded cross-sectional view of a conventional solid-state battery.

### DETAILED DESCRIPTION OF THE INVENTION

### First Embodiment

Hereinafter, a first embodiment of the present invention will be described with reference to the drawing. However, the following embodiment is only for illustration purpose and the present invention is not limited to the following embodiment.

### [Solid-State Battery]

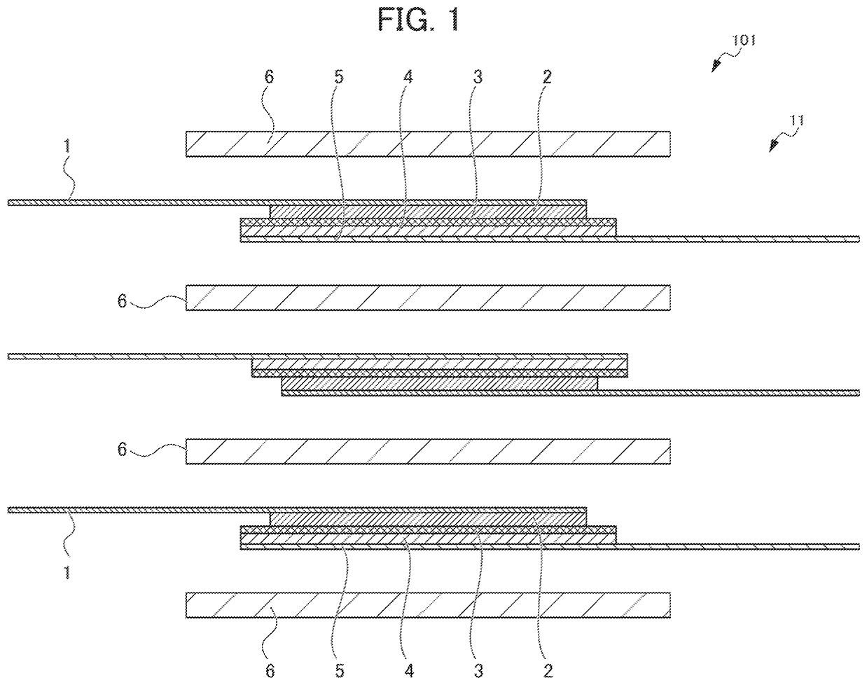

FIG. 1 is an exploded cross-sectional view illustrating a configuration of a solid-state battery 101 according to the first embodiment of the present invention. The solid-state battery 101 according to the present embodiment includes a plurality of laminates 11 and a plurality of conductive rigid bodies 6 each including a rigid body having electrical conductivity. As illustrated in FIG. 1, in the solid-state battery 101, the laminate 11 and the conductive rigid body 6 are alternately stacked, and the conductive rigid body 6 is provided on each outermost side in a stacking direction. That is, the solid-state battery 101 is manufactured by stacking and compressing each laminate in which each laminate 11 is sandwiched between the conductive rigid bodies 6.

### (Laminate)

The laminate 11 according to the present embodiment is formed by stacking a positive electrode collector 1, a positive electrode active material layer 2, a solid electrolyte layer 3, a negative electrode active material layer 4, and a negative electrode collector 5 in this order. A positive electrode layer in the laminate 11 includes the positive electrode collector 1 and the positive electrode active material layer 2, and a negative electrode layer in the laminate 11 includes the negative electrode active material layer 4 and the negative electrode collector 5.

### (Positive Electrode Layer)

The positive electrode layer is a layer which includes the positive electrode active material layer 2 containing at least a positive electrode active material and the positive electrode collector 1. As the positive electrode active material, a material capable of releasing and occluding a charge transfer medium may be selected and used as appropriate. From the viewpoint of improving the charge transfer medium conductivity, a solid electrolyte may be contained arbitrarily. In addition, to improve the electrical conductivity, a conductive auxiliary agent may be contained arbitrarily. Furthermore, from the viewpoint of exhibiting the flexibility and the like, a binder may be contained arbitrarily. As for the solid electrolyte, the conductive auxiliary agent, and the binder, those commonly used in solid-state batteries can be used.

The positive electrode active material can be the same as that used in the positive electrode layers of common solid-state batteries, and is not limited to particular materials. In lithium-ion batteries, examples of the positive electrode active material may include a layered active material containing lithium, a spinel type active material containing lithium, and an olivine type active material containing lithium. Specific examples of the positive electrode active material include lithium cobalt oxide (LiCoO₂), lithium nickel oxide (LiNiO₂), LiNiₚMn_{q}Co₁O₂ (p+q+r=1), LiNiₚAl_{q}Co₂O₂ (p+q+r=1), lithium manganese oxide (LiMn₂O₄), heterogeneous element substituted Li—Mn spinel represented by Li₁+xMn₂-x-yMyO₄ (x+y=2. M is at least one element selected from Al, Mg, Co, Fe, Ni, and Zn), lithium titanate (an ozide containing Li and Ti), and lithium metal phosphate (LiMPO₄, M is at least one element selected from Fe, Mn, Co, and Ni).

The positive electrode collector 1 may be made of any material having the function of collecting the current of the positive electrode layer. Examples of such a material may include aluminum, an aluminum alloy, stainless steel, nickel, iron, and titanium. Among the above, aluminum, an aluminum alloy, and stainless steel are preferable. Examples of the form of the positive electrode collector include a foil form and a plate form.

In the laminate 11 according to the present embodiment, edges in a planar direction of the positive electrode active material layer 2 are preferably provided on the inner side in the planar direction with respect to edges in the planar direction of the solid electrolyte layer 3 that is adjacent to the positive electrode active material layer 2. This can prevent short circuiting more reliably.

### (Solid Electrolyte Layer)

The solid electrolyte layer 3 is a layer stacked between the positive electrode layer and the negative electrode layer, the layer containing at least a solid electrolyte material. The charge transfer medium conduction can be performed between the positive electrode active material and the negative electrode active material via the solid electrolyte material contained in the solid electrolyte layer.

The solid electrolyte material may be made of any material having charge transfer medium conductivity. Examples of such a material may include sulfide solid electrolyte materials, oxide solid electrolyte materials, nitride solid electrolyte materials, and halide solid electrolyte materials. Among the above, the sulfide solid electrolyte materials are preferable. This is because the sulfide solid electrolyte materials have a charge transfer medium conductivity higher than that of the oxide solid electrolyte materials.

In lithium-ion batteries, examples of the sulfide solid electrolyte materials include Li₂S—P₂S₅, and Li₂S—P₂S₅—LiI. The description “Li₂S—P₂S₅” above means a sulfide solid electrolyte material containing a raw material containing Li₂S and P₂S₅ and the same applies also to the other description.

In lithium ion batteries, examples of the oxide solid electrolyte materials may include NASICON-type oxides, garnet-type oxides, and perovskite-type oxides. Examples of the NASICON-type oxides may include oxides containing Li, Al, Ti, P, and O (for example, Li_{1.5}Al_{0.5}Ti_{1.5} (PO₄)₃). Examples of the garnet-type oxides may include oxides containing Li, La, Zr, and O (for example, Li₇La₃Zr₂O₁₂). Examples of the perovskite-type oxides may include oxides containing Li, La, Ti, and O (for example, LiLaTiO₃).

### (Negative Electrode Layer)

The negative electrode layer is a layer which includes the negative electrode active material layer 4 containing at least a negative electrode active material and the negative electrode collector 5. From the viewpoint of improving the charge transfer medium conductivity, a solid electrolyte may be contained arbitrarily. In addition, to improve the electrical conductivity, a conductive auxiliary agent may be contained arbitrarily. Furthermore, from the viewpoint of exhibiting the flexibility and the like, a binder may be contained arbitrarily. As for the solid electrolyte, the conductive auxiliary agent, and the binder, those commonly used in solid-state batteries can be used.

The negative electrode active material may be any material capable of occluding and releasing a charge transfer medium. In lithium-ion batteries, examples of such a material may include lithium transition metal oxides such as lithium titanate (Li₄Ti₅O₁₂), transition metal oxides such as TiO₂, Nb₂O₃, and WO₃, metal sulfides, metal nitrides, carbon materials such as graphite, soft carbon, and hard carbon, metallic lithium, metallic indium, and a lithium alloy. Furthermore, the negative electrode active material may be in a power form or in a thin film form.

The negative electrode collector 5 may be made of any material having the function of collecting the current of the negative electrode layer. Examples of the material of the negative electrode collector may include nickel, copper, and stainless steel. Examples of the form of the negative electrode collector include a foil form and a plate form.

### (Conductive Rigid Body)

A plurality of conductive rigid bodies 6 are used to sandwich each of the plurality of laminates 11 therebetween. A material having electrical conductivity is used for the conductive rigid bodies 6, so that the conductive rigid bodies 6 can electrically connect the plurality of laminates 11. The laminate 11 and the conductive rigid body 6 are alternately stacked, and the conductive rigid body 6 is provided on each outermost side in the stacking direction, which makes it possible to prevent short circuiting or breakage from occurring in the electrode layers (a positive electrode layer and a negative electrode layer) of the individual laminates 11 due to rolling when the solid-state battery 101 is pressed,

The conductive rigid body 6 may be made of any material having electrical conductivity, and is preferably made of a metal material and more preferably made of stainless steel (SUS). The conductive rigid body 6 has preferably a length in the planar direction that is greater than that of the electrode layers of the laminate 11 facing the conductive rigid body 6. The conductive rigid body 6 has preferably a thickness of several hundreds μm.

### [Manufacturing Method]

Hereinafter, a method of manufacturing of the solid-state battery 101 according to the present embodiment will be described. However, the solid-state battery 101 according to the present embodiment can be manufactured while making appropriate modifications within the scope of the purpose of the present invention.

### (Method of Manufacturing Positive Electrode Layer)

A positive electrode layer can be manufactured by disposing a positive electrode mixture containing the positive electrode active material on the surface of the positive electrode collector 1. The method of manufacturing the positive electrode layer may be the same method as before, and the positive electrode can be manufactured by any one of a wet method and a dry method. Hereinafter, there will be described a case of manufacturing the positive electrode by the wet method.

The positive electrode layer is manufactured by the steps of obtaining a positive electrode mixture paste containing a positive electrode mixture and a solvent, and coating the positive electrode mixture paste on the surface of the positive electrode collector 1 and drying the paste to form a positive electrode active material layer 2 on the surface of the positive electrode collector 1. For example, the positive electrode mixture paste is obtained by mixing and dispersing the positive electrode mixture in the solvent. The solvent used in this case is not limited to particular solvents, and may be selected as appropriate depending on the properties of the positive electrode active material, the solid-state electrolyte, and the like. For example, non-polar solvents such as heptane are preferable. Various mixing and dispersing devices such as an ultrasonic dispersion device, a shaking apparatus, and a FILMIX (registered trademark) can be used for mixture and dispersion of the positive electrode mixture and the solvent. The solid content in the positive electrode mixture paste is not limited to particular contents.

The positive electrode layer can be obtained by coating and drying the positive electrode mixture paste obtained in this way on the surface of the positive electrode collector 1 to form the positive electrode active material layer 2 on the surface of the positive electrode collector 1. The means for coating the positive electrode paste on the surface of the positive electrode collector 1 may be a well-known coating means such as a doctor blade or the like. A total thickness (a thickness of the positive electrode) of the dried positive electrode active material layer 2 and positive electrode collector 1 is not limited to particular thicknesses, but from the viewpoint of energy density and stackability for example, the total thickness is preferably 0.1 μm or more and 1 mm or less, and more preferably 1 μm or more and 100 μm or less. In addition, the positive electrode may be manufactured through a process of pressing arbitrarily. In addition, the positive electrode layer may be manufactured by coating and drying the positive electrode mixture paste on the surface of a resin film to form the positive electrode active material layer 2, and releasing the resin film. In this case, it is preferable to coat a mold-release agent on the resin film in advance.

### (Method of Manufacturing Solid Electrolyte Layer)

The solid electrolyte layer 3 can be manufactured through, for example, a step of pressing the solid electrolyte and the like. Alternatively, the solid electrolyte layer 3 can also be manufactured through a process of coating, on the surface of a substrate or an electrode, a solid electrolyte paste which is prepared by dispersing the solid electrolyte and the like in a solvent. The solvent used in this case is not limited to particular solvents, and may be selected as appropriate depending on the properties of the binder or the solid electrolyte. A thickness of the solid electrolyte layer 3 varies greatly depending on the configuration of the battery, and the thickness is, for example, preferably 0.1 μm or more and 1 mm or less, and more preferably 1 μm or more and 100 μm or less.

### (Method of Manufacturing Negative Electrode Layer)

Similar to the positive electrode layer, for example, the negative electrode layer can be manufactured through the steps of producing a negative electrode mixture paste by adding a negative electrode active material and the like to a solvent, and then using an ultrasonic dispersion device or the like to disperse the solution, and coating the negative electrode mixture paste on the surface of the negative electrode collector 5 and then drying. The solvent used in this case is not limited to particular solvents, and may be selected as appropriate depending on the properties of the negative electrode active material, and the like. A thickness of the negative electrode layer is, for example, preferably 0.1 μm or more and 1 mm or less, and more preferably 1 μm or more and 100 μm or less. In addition, the negative electrode may be manufactured through a process of pressing. The negative electrode layer may be manufactured by coating and drying the negative electrode mixture paste on the surface of a resin film to form the negative electrode active material layer 4, and releasing the resin film. In this case, it is preferable to coat a mold-release agent on the resin film in advance.

### (Method of Manufacturing Laminate)

In the present embodiment, a method of manufacturing the laminate 11 includes a step of stacking the above-described positive electrode layer, the solid electrolyte layer 3, and the negative electrode layer in this order. The stacking method can be a well-known method. At this time, the laminate 11 thus manufactured may be pressed through a process of pressing.

The adhesion of the laminate 11 is improved by pressing the laminate 11. Pressing means can be a common method such as uniaxial or biaxial pressing, roll-pressing, or the like. A pressure during pressing is preferably applied for pressing until the interface of each layer is bonded and becomes tight.

### (Method of Manufacturing Solid-State Battery)

The solid-state battery 101 according to the present embodiment includes, for example, a plurality of conductive rigid bodies 6 and a plurality of laminates 11, and is manufactured by stacking and high-pressure pressing each laminate in which each laminate 11 is sandwiched between the conductive rigid bodies 6. Pressing means can be a common method such as uniaxial or biaxial pressing, roll-pressing, or the like. A pressure during pressing is preferably applied for pressing until the conductive rigid bodies 6 and the laminate 11 become tight.

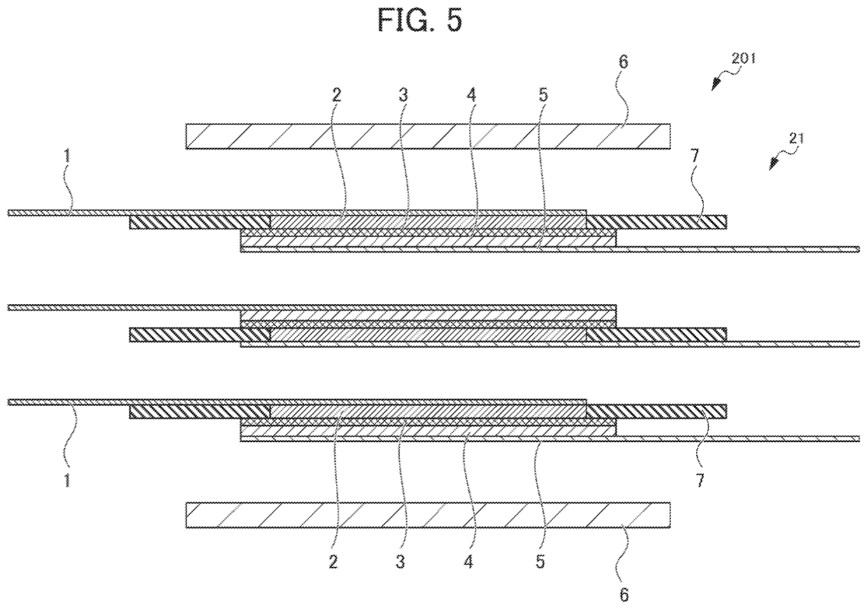

According to the solid-state battery 101 according to the present embodiment, the following effects can be achieved. That is, in the solid-state battery 101 according to the present embodiment, the laminate 11 and the conductive rigid body 6 are alternately stacked, and the conductive rigid body 6 is provided on each outermost side in a stacking direction. Thus, each of the laminates 11 is sandwiched between the conductive rigid bodies 6, which makes it possible to prevent short circuiting or breakage from occurring in electrode layers in individual laminates 11 due to rolling when the laminates 11 are stacked and then pressed. Here, FIG. 5 is an exploded cross-sectional view of a conventional solid-state battery 201, and in the conventional solid-state battery 201, since laminates 21 are continuously provided at a center in the stacking direction, each of the laminates 11 is not sandwiched by the conductive rigid bodies 6, short-circuiting or breakage occurs in the electrode layers due to rolling. However, according to present embodiment, this can be prevented.

### Second Embodiment

Next, a second embodiment of the present invention will be described with reference to the drawing. As for configurations that are identical to those in the first embodiment, description thereof will be omitted as appropriate. However, the following embodiment is only for illustration purpose and the present invention is not limited to the following embodiment.

### [Solid-State Battery]

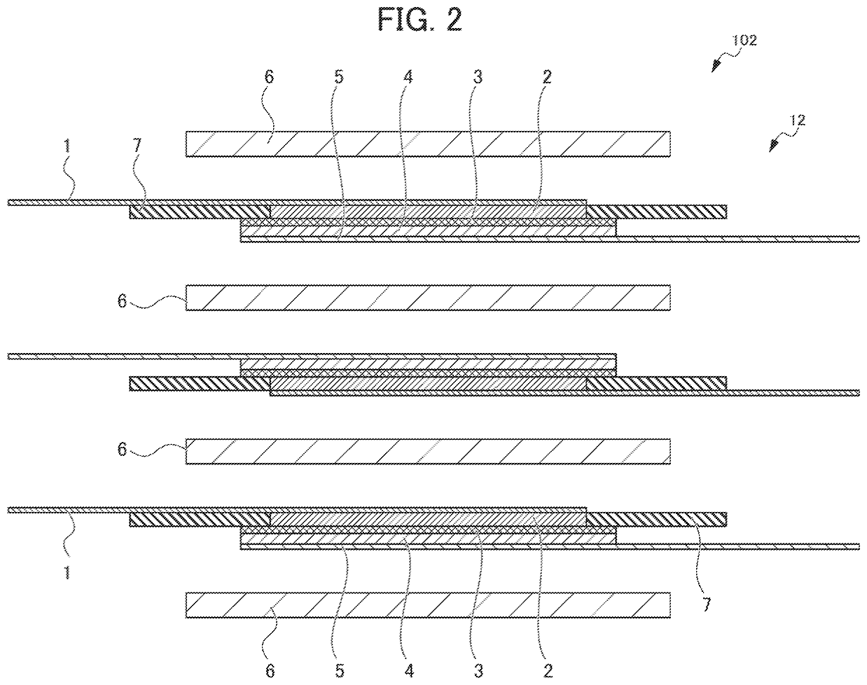

FIG. 2 is a cross-sectional view illustrating a configuration of a solid-state battery 102 according to the second embodiment of the present invention. The solid-state battery 102 according to the present embodiment is different from the solid-state battery 101 according to the first embodiment in that an insulating spacer 7 is provided outside in the planar direction of the positive electrode active material layer 2, and the other configurations are the same as those in the first embodiment.

### (Insulating Spacer 7)

The insulating spacer 7 is provided outside in the planar direction of the positive electrode active material layer 2 of the laminate 12 to electrically insulate between the positive electrode layer and the negative electrode layer of the laminate 12. The insulating spacer 7 may be made of any insulating material, and a well-known material can be applied for the insulating spacer 7. The insulating spacer 7 is provided outside in the planar direction of the positive electrode layer included in the laminate 12, whereby short circuiting can be more reliably prevented from occurring due to the breakage of the electrode layers occurring when the solid-state battery 102 is manufactured by stacking and then high-pressure pressing a plurality of laminates 12. After the laminate 12 is manufactured by a manufacturing method similar to the manufacturing method for the laminate 11 described in the first embodiment, the insulating spacer 7 can be provided by being inserted onto the solid electrolyte layer 3 from the outside in the planar direction of the positive electrode active material layer 2. Alternatively, in a manner similar to the formation of the positive electrode active material layer 2, the insulating spacer 7 can be formed by coating and drying the paste containing the constituent material of the insulating spacer 7.

According to the solid-state battery 102 according to the present embodiment, the effects similar to those of the first embodiment can be achieved. The insulating spacer 7 is provided outside in the planar direction of the positive electrode active material layer 2, whereby short circuiting can be more reliably prevented from occurring due to rolling when the laminates 12 are stacked and then pressed at a high pressure.

### Third Embodiment

Next, a third embodiment of the present invention will be described with reference to the drawing. As for configurations that are identical to those in the first and second embodiments, description thereof will be omitted as appropriate. However, the following embodiment is only for illustration purpose and the present invention is not limited to the following embodiment.

### [Solid-State Battery]

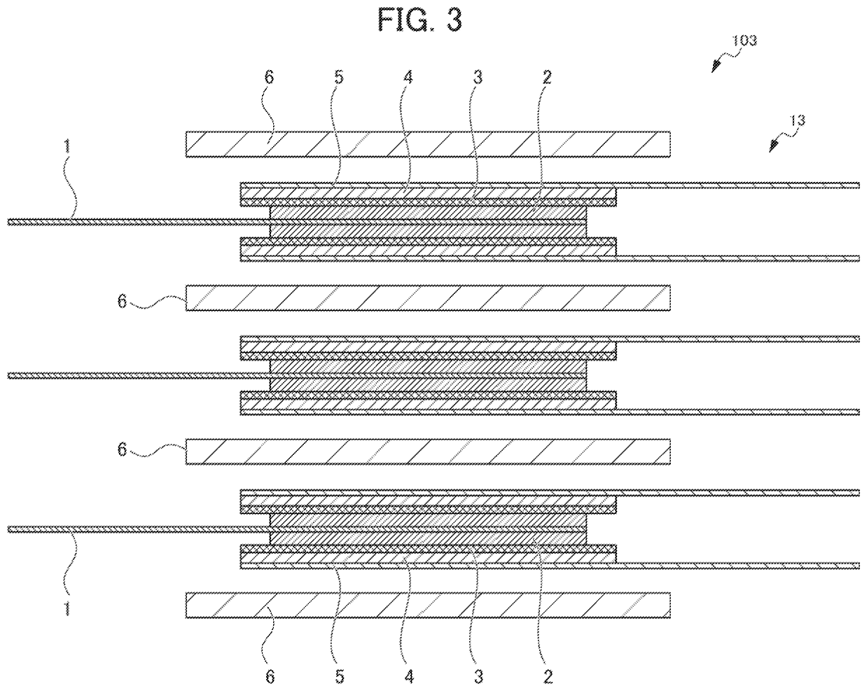

FIG. 3 is a cross-sectional view illustrating a configuration of a solid-state battery 103 according to the third embodiment of the present invention. The solid-state battery 103 according to the present embodiment is different from the solid-state battery 101 according to the first embodiment in that an assembly 13 is provided in which a pair of laminates having the same configuration as that of the laminate 11 of the first embodiment are stacked so that the positive electrode collectors 1 thereof contact each other, and the assembly 13 and the conductive rigid body 6 are alternatively stacked. The other configurations are the same as those in the first embodiment.

### (Assembly)

The assembly 13 according to the present embodiment is formed by stacking a pair of laminates each in which the positive electrode collector 1, the positive electrode active material layer 2, the solid electrolyte layer 3, the negative electrode active material layer 4, and the negative electrode collector 5 are stacked in this order, so that the positive electrode collectors 1 thereof contact each other as described above. The assembly 13 is manufactured by bonding the positive electrode collectors of the pair of laminates as described above, and the bonding method can be a conventional well-known method.

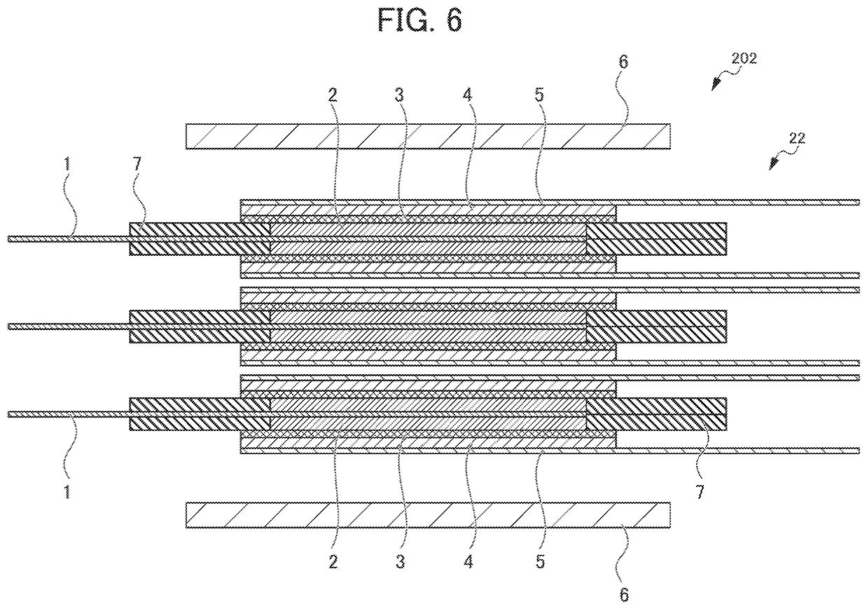

According to the solid-state battery 103 according to the present embodiment, the effects similar to those of the first embodiment can be achieved. Here, FIG. 6 is an exploded cross-sectional view of a conventional solid-state battery 202, and in the conventional solid-state battery 202, since assemblies 22 are continuously provided at a center in the stacking direction, each of the assemblies 22 is not sandwiched by the conductive rigid bodies 6, short-circuiting or breakage occurs in the electrode layers due to rolling. However, according to present embodiment, this can be prevented. According to the present embodiment, there is provided an assembly 13 in which the pair of laminates each in which the positive electrode collector 1, the positive electrode active material layer 2, the solid electrolyte layer 3, the negative electrode active material layer 4, and the negative electrode collector 5 are stacked in this order are stacked so that the positive electrode collectors 1 thereof contact each other, whereby higher output may be achieved by direct connection of the electrode layers.

### Fourth Embodiment

Next, a fourth embodiment of the present invention will be described with reference to the drawing. As for configurations that are identical to those in the first to third embodiments, description thereof will be omitted as appropriate. However, the following embodiment is only for illustration purpose and the present invention is not limited to the following embodiment.

### [Solid-State Battery]

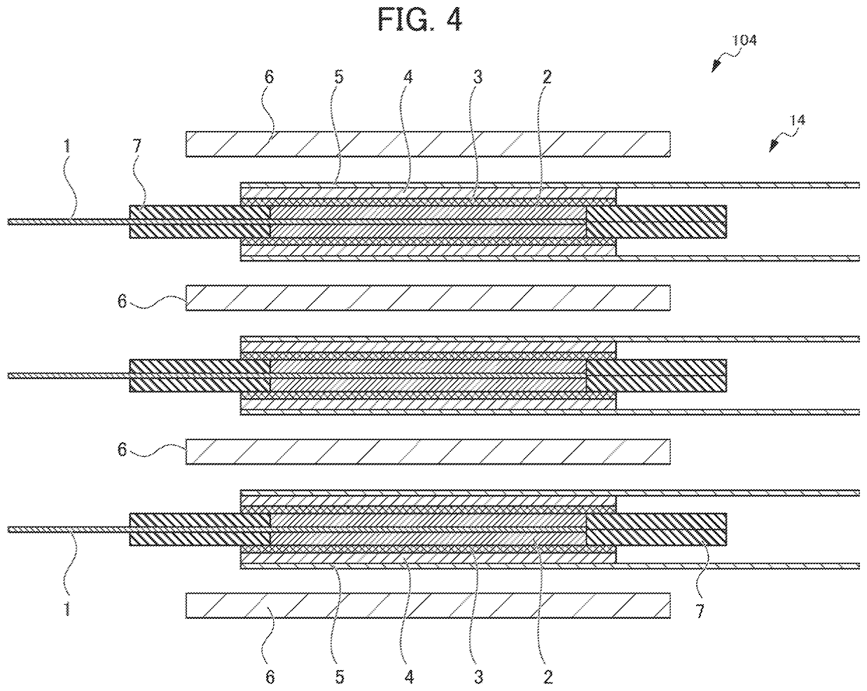

FIG. 4 is a cross-sectional view illustrating a configuration of a solid-state battery 104 according to the fourth embodiment of the present invention. The solid-state battery 104 according to the present embodiment is different from the solid-state battery 103 according to the third embodiment in that an insulating spacer 7 is provided outside in the planar direction of the positive electrode active material layer 2, and the other configurations are the same as those in the third embodiment. Note that the insulating spacer 7 has the same configuration as that of the insulating spacer 7 of the second embodiment.

According to the solid-state battery 104 according to the present embodiment, the effects of the first to third embodiments can be enhanced.

It is noted that the present invention is not limited to the above-described embodiments, and includes modifications and improvements within the scope which can achieve the object of the present invention.

### EXPLANATION OF REFERENCE NUMERALS

1 positive electrode collector
2 positive electrode active material layer
3 solid electrolyte layer
4 negative electrode active material layer
5 negative electrode collector
6 conductive rigid body
7 insulating spacer
11, 12, 21, 22 laminate
13, 14 assembly
101, 102, 103, 104 solid-state battery

What is claimed is:

1. A solid-state battery comprising:
a laminate in which a positive electrode collector, a positive electrode active material layer, a solid electrolyte layer, a negative electrode active material layer, and a negative electrode collector are stacked in this order; and
a conductive rigid body including a rigid body having electrical conductivity,
wherein the laminate and the conductive rigid body are alternately stacked, and the conductive rigid body is provided on each outermost side in a stacking direction.

2. A solid-state battery comprising:
an assembly in which a pair of laminates each in which a positive electrode collector, a positive electrode active material layer, a solid electrolyte layer, a negative electrode active material layer, and a negative electrode collector are stacked in this order are stacked so that the positive electrode collectors of the pair of laminates contact each other; and
a conductive rigid body including a rigid body having electrical conductivity,
wherein the assembly and the conductive rigid body are alternately stacked and the conductive rigid body is provided on each outermost side in a stacking direction.

3. The solid-state battery according to claim 1, wherein edges in a planar direction of the positive electrode active material layer are provided on an inner side in the planar direction with respect to edges in the planar direction of the solid electrolyte layer that is adjacent to the positive electrode active material layer.

4. The solid-state battery of claim 1, further comprising:
an insulating spacer provided outside in a planar direction of the positive electrode active material layer.
